(19) United States
(12) Patent Application Publication
(10) Pub. No.: US 2022/0117443 A1
(43) Pub. Date: Apr. 21, 2022

(54) SYSTEM WITH FOOD PROCESSOR AND METHOD

(71) Applicant: VORWERK & CO. INTERHOLDING GMBH, Wuppertal (DE)

(72) Inventors: Matthias Stein, Mülheim an der Ruhr (DE); Miron Sernecki, Hagen (DE)

(21) Appl. No.: 17/496,236

(22) Filed: Oct. 7, 2021

(30) Foreign Application Priority Data
Oct. 16, 2020 (EP) 20202271.1

(51) Int. Cl. A47J 43/046; A47J 27/00; A47J 36/32; G05B 19/042

(52) U.S. Cl. CPC A47J 43/046; A47J 27/004; G05B 2219/2643; G05B 19/042; A47J 36/321

(57) ABSTRACT

A system comprising a food processor for preparing a food in a food preparation vessel and/or another kitchen appliance, and to a method and a computer program product. The food processor comprises a tool for mixing or chopping the food in the food preparation vessel. A control unit can access a recipe and be caused by a recipe step of the recipe (26) to operate the tool and/or the heating element in a manner defined by the recipe step. The control unit is configured such that a desired time is defined during the food preparation process or for a completion of at least two recipe steps. In this way, it is possible to monitor a food preparation process during the performance with regard to completion times. Depending on the monitoring, measures can be taken to optimize a preparation of one or more foods in terms of time.

### CROSS-REFERENCE TO RELATED APPLICATIONS

This application claims priority to and benefit of European Patent Application Number 20202271.1, filed Oct. 16, 2020, the disclosure of which is incorporated hereby in its entirety by reference herein.

### TECHNICAL FIELD

The present disclosure relates to a system comprising a food processor for preparing a food in a food preparation vessel and/or another kitchen appliance. The present disclosure further relates to a method and a computer program product. The food processor comprises a tool for mixing or chopping the food in the food preparation vessel. The food processor comprises a food preparation vessel detachable from a base portion of the food processor. The food processor may comprise a heating or cooling element for cooling or heating the food in the food preparation vessel.

### BACKGROUND

Food processors that can access recipes for semi-automated preparation of a food are known. To prepare a food, a user performs the recipe steps in the sequence specified by the recipe, as when cooking according to a recipe in a cookbook. Such a food processor can perform recipe steps in a semi-automated manner based on a recipe. Inputs or activities by the user may be required between such recipe steps. In particular, the disclosed system comprises such a food processor.

The publications WO 2018/054 668 A1 and EP 3 515 266 A1 describe methods for processing a recipe.

Reference is made to patent applications EP 20 154 494.7 and EP 19 170 795.9, which also deal with food processors that enable food to be prepared by means of digital recipes with multiple recipe steps.

It is an object of the present disclosure to provide a further developed system and a further developed method.

### SUMMARY

A system comprising a food processor for preparing a food in a food preparation vessel and/or another kitchen appliance serves to solve the task. In particular, the kitchen appliance is a food preparation appliance. A control unit may access a recipe. The control unit may control the preparation of one or more foods, in particular by a recipe step of the recipe. For example, a tool and/or a heating element of the food processor may be operated in a manner defined by the recipe step. The control unit may directly control the operation of the tool and/or heating element, or it may prompt a user to manually set parameters for the operation.

The control unit is configured such that the control unit compares a desired time during the preparation of the food and/or for a completion of at least two recipe steps with an actual time. The comparison is performed during the food preparation process, i.e., before the food is completely prepared. A so-called “live monitoring” is thus made possible and the conditions for a “live optimization” of the food preparation process are created. The system according to the present disclosure thus enables a food preparation process to be monitored during performance with regard to the duration to completion or the completion time. In other words, an improved adherence to the originally scheduled completion time with a reproducible cooking result can be made possible even in the event of time deviations during the food preparation process.

The desired time for a completion of at least two recipe steps is defined by the control unit. The control unit, which is configured such that it compares a desired time during the preparation of the food and/or for a completion of at least two recipe steps with an actual time, does not necessarily define the desired value for the completion of at least two recipe steps, which will be discussed in more detail later. Alternatively, the recipe may comprise a desired time for the at least two recipe steps. The desired time is preferably a duration of time provided for processing, i.e. performing, the at least two recipe steps. This desired time is compared with an actual time. The actual time is preferably the time actually spent during the performance of the at least two recipe steps. Thus, it is monitored whether the actual time corresponds to the desired time or whether there are deviations therefrom. In other words, it is monitored whether a time schedule is being adhered to or can be adhered to. The result of the monitoring can be used in different ways. For example, the result of the monitoring can be used to inform the user(s) that the food will not be ready until a later time compared to an original schedule. The monitoring result can be used to speed up preparation steps or to modify a sequence of preparation steps in order to still be able to adhere to a schedule after all, when a determined actual time deviates from a specified desired time.

A recipe for purposes of the present disclosure is an electronically stored recipe. It may be a digitally stored recipe. A recipe is divided into a plurality of recipe steps. A recipe step is a step that must be performed to prepare a food. For example, the recipe provides that Parmesan cheese is to be chopped by a food processor or blender. The recipe may then comprise the following recipe steps:
first recipe step: add chopped Parmesan pieces to the food preparation vessel of the food processor;
second recipe step: place the lid on the food preparation vessel;
third recipe step: activate a start button; and
fourth recipe step: chop the Parmesan in the vessel for 10 seconds at maximum rotation speed.

Recipe step therefore means a single, integral activity of a user, a food processor or another kitchen appliance, which in principle cannot be further subdivided.

For each recipe step, the recipe includes one or more pieces of information for the control unit, which can be evaluated by the control unit.

Information is available to the control unit in such a way that the control unit can process the available information and thereby optimize

instructions and/or a process for preparing a food. Information for the control unit is not present if a user can receive and understand information, but this information is not available in a form that the control unit can “understand” in order to be able to use the information, for example, for optimization calculations.

The information may comprise a desired time for a recipe step, i.e., the time required to perform the recipe step. In particular, there may be a desired time for each recipe step of a recipe. However, there may also be a desired time for two recipe steps. For example, the recipe includes information for the control unit that 10 seconds of time are required for the first recipe step mentioned above, a total of 5 seconds of time are required for the second and third recipe steps mentioned above, and 15 seconds of time are required for the fourth recipe step mentioned above. For the fourth recipe step, for example, 15 seconds (and not merely 10 seconds) may be provided because it comprises that in a working step of the food processor the placed lid is locked in an automated manner prior to chopping by the food processor and is unlocked in an automated manner following the chopping and is chopped in an automated manner in between. From this information, the control unit can now determine a desired time of 10 seconds+5 seconds+15 seconds=30 seconds, which is scheduled for performing the four recipe steps. When the start button is activated, the control unit can thereby obtain information on the actual time, i.e. the time actually spent on performing the first two recipe steps. For example, the control unit can determine in this way that 30 seconds have been spent on performing the first three steps, and that a time delay of 15 seconds has therefore occurred. The control unit can now notify, for example via a loudspeaker or via a display, about the delay that has occurred. The control unit can, for example, cause that in the fourth recipe step chopping is only performed for 8 seconds to make up for time. The control unit can, for example, adjust the desired times stored in the recipe step for the first three recipe steps in order to be able to adhere to schedules in an improved manner the next time. An adjustment can be performed, for example, if the control unit repeatedly determines that a user regularly exceeds certain desired times. Conversely, desired times can also be shortened if the control unit finds that a user regularly undercuts a desired time stored in the recipe. The result of the monitoring can thus be used in many different ways to optimize food preparations.

Thus, for example, the systems and methods of the present disclosure may take into account time delays. Time delays may be caused by a user, for example, if the user needs more time for a user action scheduled in the recipe than scheduled in the recipe. In particular, the at least one desired time depends on a duration of a user action scheduled in the recipe. For example, a delay by the user may occur because the user was temporarily busy elsewhere in an unscheduled manner or failed to perform the user action specified by the recipe, such as pressing a start button, e.g., an icon on a touch-sensitive display, that initiates the start of the next recipe step. The systems and methods of the present disclosure makes it possible to respond to such events. In one configuration, the two recipe steps for whose completion a desired time is defined and compared with an actual time comprise a process performed by a functional component and a user action scheduled in the recipe.

In the following, exemplary embodiments of the systems and methods of the present disclosure are also explained in more detail with reference to figures. Features of the exemplary embodiments may be combined individually or in a plurality with the claimed subject matter, unless otherwise indicated. The claimed scopes of protection are not limited to the exemplary embodiments.

### BRIEF DESCRIPTIONS OF THE DRAWINGS

The figures show:

FIG. 1: a schematic representation of a food processor;

FIG. 2: a schematic representation of a kitchen appliance;

FIG. 3: a schematic representation of a recipe with a comparison of a desired time with an actual time;

FIG. 4: a schematic representation of the monitoring of a food preparation operation;

FIG. 5: illustration of a first example of a modification in the recipe based on the monitoring by comparing the desired time with the actual time; and

FIG. 6: illustration of a second example of a modification of the recipe based on the monitoring.

### DETAILED DESCRIPTION

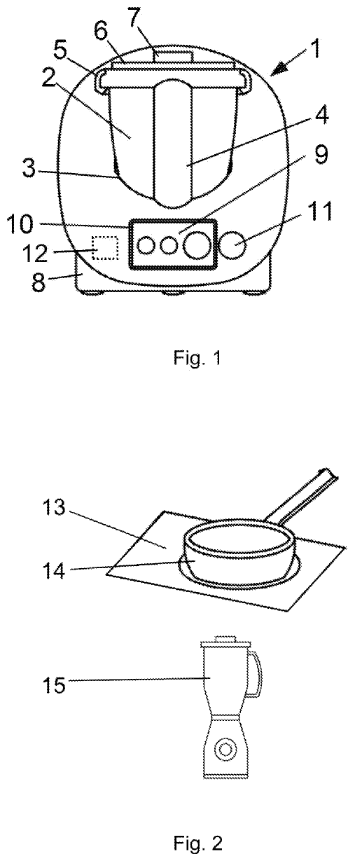

FIG. 1 shows a food processor 1 which can be part of the system according to the invention. The food processor 1 comprises a food preparation vessel 2, which is inserted into a holder 3 of the food processor 1. The food preparation vessel 2 comprises a handle 4 for easily removing the food preparation vessel 2 from the holder 3. In particular, the food processor 1 comprises a closing mechanism with, for example, pivotally mounted arms 5. In the closed position shown in FIG. 1, the arms 5 enclose a lid 6. As a result, the lid 6 is then firmly connected to the food preparation vessel 2. The lid 6 comprises an opening into which a vessel 7 is inserted, for example a transparent vessel. The vessel 7 closes the opening in the lid 6. The vessel 7 can be lifted off the opening at any time, so that an opening is then provided through which an ingredient can be filled into the food preparation vessel 2. The vessel 7 can serve as a dosing aid. When the closing mechanism is opened, the lid 6 can be removed from the food preparation vessel 2. The food processor 1 comprises a scale 8 integrated in the foot part.

A user interface 9 is displayed on a screen 10. The screen 10 is preferably touch-sensitive in order to be able to set operating parameters by touching the screen, for example. The screen 10 serves as an input and output unit. The food processor may comprise as an additional input unit, for example, a rotary and/or push button 11, which may also serve to be able to set one or more operating parameters in interaction with the user interface 9. For example, if the user interface 9 requests a confirmation from the user regarding a completed recipe step, the confirmation can be entered by pressing the rotary and/or push button 11. For example, if the user interface 9 relates to a mixing and cutting device of the food processor 1, then by rotating the rotary and/or push button 11, a rotation speed can be set. Rotating the rotary knob and/or push button 11 can also be used, for example, to set time durations for specific food preparation processes and/or temperatures.

The food processor 1 comprises a schematically illustrated control unit 12 with a processor and a memory, which can access a digital recipe and be caused by a recipe step of the recipe to operate the functional components of the food processor 1 and further kitchen appliances as defined in the recipe step. The control unit 12 may further be configured to set operating parameters of the functional components differently from what is defined in the recipe step. In particular, the control unit 12 is provided with a preferably wireless transmitting and/or receiving unit to produce respective data connections to an external device. The external device is, for example, a cloud computer, a mobile communication device such as a smartphone or tablet computer, or another kitchen appliance. In addition, the control unit 12 may be configured to optimize the digital recipe for the food preparation operation. For example, individual recipe steps or food preparation processes defined in individual recipe steps can be assigned to available functional components. The control unit 12 may be configured to determine available functional components.

The system may comprise one or more of the other kitchen appliances shown in FIG. 2, namely a hob 13 with a pan 14 and a mixer 15. Each of the kitchen appliances may comprise a sending and/or receiving unit through which electronic data may be exchanged, for example with each other, with the food processor 1 and/or with an external computer which may be physically separate from the kitchen appliances.

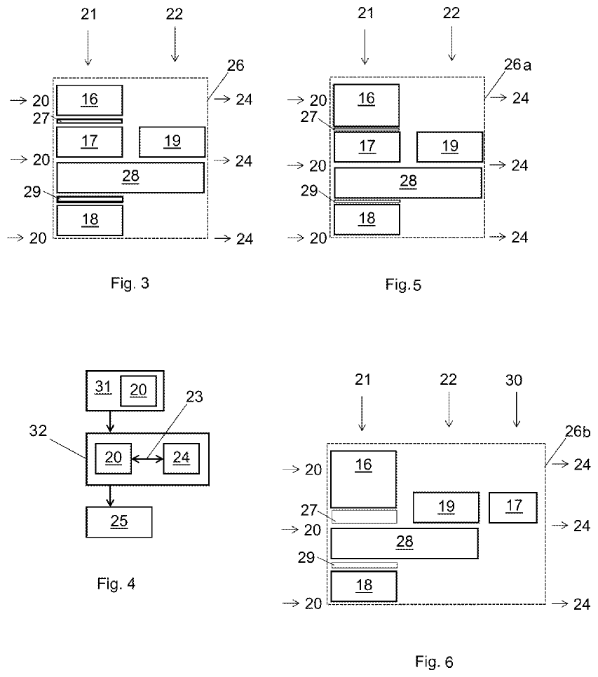

FIG. 3 shows the exemplary sequence of a food preparation operation according to a recipe 26 with a comparison of a desired time 20 with an actual time 24, preferably at several points of time during the food preparation operation. In particular, the recipe 26 of FIG. 3 does not include any steps other than those shown in FIG. 3. The recipe steps 16, 17, 18 of the recipe 26 are arranged in a first path 21 and the recipe step 19 of the recipe 26 is arranged in a second path 22. Both paths 21, 22 are to be performed at least temporarily at the same time using different kitchen appliances, for example by the food processor 1 (e.g. from FIG. 1) and at least one other kitchen appliance, e.g. the pan 14 on the hob 13 from FIG. 2. For example, recipe step 16 is directed to adding onions to the food preparation vessel 2 with a specified quantity that can be checked by means of the scale 8. A buffer time 27 is provided for recipe step 16. For example, recipe step 17 is directed to sautéing the onions, which can preferably be performed in the food preparation vessel 2 with a heating element of the food processor or, alternatively, with the pan 14 on the hob 13 according to the recipe 26. For example, recipe step 19 is directed to chopping tomatoes, which can preferably be performed with the mixing device 15 or alternatively with the tool of the food processor. For example, recipe step 28 is directed to merging the chopped tomatoes and sautéed onions, wherein the manual merging is also provided with a buffer time 29. For example, recipe step 18 is directed to heating and simultaneously mixing the merged food, which can be realized simultaneously by the heating element and the tool of the food processor. Recipe steps 16, 17 and 18 are necessarily to be carried out in this sequence. Recipe step 19 can be executed before recipe step 28 in an independent and parallel manner Since recipe step 19 requires a shorter time duration than the sum of recipe steps 16 and 17, the start time of recipe step 19 can also be freely selected within a certain time window. The first path 21 is decisive with respect to the time duration and accordingly is the critical path here. In one embodiment, all recipe steps of a path are performed on one and the same kitchen appliance. In one embodiment, a recipe such as recipe 26 defines the food preparation operation.

Preferably, the recipe steps of path 21 are performed by or in conjunction with the food processor. Preferably, the recipe step 19 of path 22 is performed on the mixer 15.

In FIG. 3 it is apparent that at least one desired time 20, preferably several desired times 20, is defined during the food preparation operation and/or for the completion of at least two recipe steps, e.g. recipe steps 16 and 17. When a condition linked with a respective desired time 20 is detected as met by the control unit 12, a detection of the actual time 24 and a comparison of the desired time with the actual time is performed. The first desired time is compared with an actual time 24 during the recipe step 16. The condition for this is linked to the achievement of a defined weight by added onions, which is lower than the weight of the onions to be added required by the recipe. In this way, it is ensured in the best possible way that the comparison of the desired time with the actual time is performed before the end of this recipe step. A further comparison of a desired time with an actual time is performed as already mentioned after recipe steps 16 and 17 and optionally at the end of the food preparation operation. The comparison of the desired time with the actual time on completion of the food is optional as mentioned and serves, for example, to check the success of the measures initiated after a time deviation has been detected.

FIG. 4 schematically shows the monitoring of a food preparation operation. First, a definition 31 of the desired time 20 is performed. This can be performed on the basis of the specifications of the recipe 26. Then a monitoring 32 of the desired time 20 is performed by a comparison 23 of the desired time 20 with the actual time 24, as already explained above. If the comparison 23 results in a deviation of the desired time 20 from the actual time 24 and, in particular, if the deviation exceeds a certain threshold value, a measure 25 is initiated. In particular, this is a measure for shortening the food preparation operation, so that, for example, a time delay having the amount of the determined deviation is partially or completely compensated. In particular, the measure is initiated by the control unit. The initiation of the measures comprises, in particular, the corresponding control of the functional components, i.e., for example, the operation of the functional components with changed operating parameters. If no deviation is determined, typically no measures are initiated.

The measures provided, for example, are described below. In particular, an adjustment of the start time of at least one outstanding recipe step is considered first. If this is not sufficient, a buffer time provided between recipe steps can be used up. Pause times can be introduced to extend a food preparation process. If this is not sufficient, working through the recipe according to the original schedule with subsequent keeping warm can be considered. If the steps mentioned so far are not sufficient, cooking parameters could be changed in the critical path. If this is also not sufficient, a new scheduling, i.e., temporal arrangement, of the outstanding recipe steps with possibly further parallelization can be considered. If the above measures are unsuccessful, the causative path can be defined to be the critical path and the steps can be repeated in that order. For example, the causative path is the path that comprises the delaying manual steps. Finally, a combination of the mentioned measures is also possible.

FIG. 5 illustrates the case where the user needs more time than provided in the original recipe 26 (FIG. 3) to put the correct amount of onions with the required weight into the food preparation vessel 2 of the food processor. The fact that a time delay was approaching was already detected by the control unit 12 when half of the required weight of onions was reached by comparing the desired time with the actual time. As an initiated measure, the buffer times 27 and 29 were reduced and a correspondingly modified recipe 26a was generated. In this way, the time delay could be compensated and the food could be completed in time as scheduled and with the provided quality.

FIG. 6 also illustrates the case where the user needs more time than provided in the original recipe 26 (FIG. 3) to put the correct amount of onions with the required weight into the food preparation vessel 2 of the food processor. However, the time delay detected by the control unit 12 by comparing the desired time with the actual time, analogous to the example of FIG. 5, was greater than in the example of FIG. 5, and greater than the buffer times 27 and 29. Therefore, the control unit 12 initiated the measure for the modified recipe 26b, according to which the recipe step 17 (sautéing the onions) is executed on an additional path 30 in a parallelized manner by the pan 14 on the hob 13. The sautéing of the onions of the recipe step 17 is therefore no longer performed by the food processor as originally scheduled in FIG. 3. Because the chopping of the tomatoes in recipe step 19 in parallel in the mixer 15 could no longer be brought forward in time and also the sautéing of the onions of recipe step 17 in the additional path 30 could also not be completed earlier, the buffer time 27 was extended, i.e., a pause was added. As the comparison of the desired time with the actual time after recipe steps 16, 17 and 19 showed, the previously detected time deviation, i.e., time delay in this case, could be completely made up and consequently successfully compensated by the initiated measure. Recipe step 28 therefore started on schedule and the overall food preparation operation was also completed as originally scheduled.

In particular, an adjustment or approximation of the recipe to an optimum is sought by the control unit 12. This may involve time, or alternatively energy efficiency, ergonomics, other target variables, or combinations thereof. A computer-implemented method may comprise generating machine-readable code based on the optimized recipe. In particular, this includes the assignments and/or desired times. The code may be configured to directly activate the kitchen appliances to perform the food preparation operation. Accordingly, the kitchen appliances may be operated based on the code even without their own controls. The method may comprise translating the code into a code interpretable by third-party kitchen appliances. This may comprise a call to an abstract function description and/or a programming interface, which are subsequently converted into calls specific to the third-party kitchen appliance. This may be performed when creating or executing the optimized recipe in the form of the generated code.

The translation can be performed on different levels. In the simplest case, it may be possible to display a device-specific setting to the user as a recipe step. For this, the recipe may include information on how the setting can be described abstractly. For this purpose, a recipe step should in particular include the following information: the type of kitchen appliance, for example “stove”, the setting of the kitchen appliance on an abstract level, for example “medium heat”, and/or information on the activation of the kitchen appliance.

In one embodiment, the control unit 12 has a machine learning algorithm that can, for example, allow a food processor or kitchen appliance to perform recipe steps in an automated manner. This may require a different number of steps with corresponding operating parameters depending on the kitchen appliance. In particular, sensor values may also be stored in the recipe steps, for example with respect to a core temperature. For example, a common instruction for preparing a steak is “sear over high heat and then cook over medium heat for three minutes on each side.” In this, several recipe steps with different operating parameters are hidden. There is a need to generate appliance-specific instructions and control commands, especially operating parameters, from a recipe that is as general as possible and valid for different kitchen appliances, such as the above instruction. These may, for example, be specific to the system, the food processor and/or the kitchen appliances available for the current food preparation operation. This may be performed by having a kitchen appliance database and/or a database that can be accessed during the performance of the computer-implemented method include automatic programs for specific foods, in addition to any simple control commands that may be available. These may comprise one or more recipe steps, one or more operating parameters, settings and/or sensor values. Decision making as to whether an automated program is applicable to a recipe may comprise using at least one food product to be processed as a source of information. The method may comprise that one or more automated programs which are individually adapted to kitchen appliances to be used can be selected, for example based on recipe ingredients and/or process steps. This may be performed by means of the control unit.

A food preparation operation is an operation in which at least one food is processed. In particular, a food preparation operation extends to the completion of a food or all scheduled foods, such as appetizer and main dish or meat and sauce. A food preparation operation may also comprise a temporary temporal interruption in the processing of the food. For example, all functional components may come to rest when the user is caused by the recipe to prepare ingredients outside of the food processor or a kitchen appliance. A food preparation operation may comprise preparing a food in the preparation vessel. It may comprise preparing multiple foods or multiple parts of foods. Preparing a food in the food preparation vessel may be a food preparation operation or a part of a food preparation operation. For example, a food preparation operation may be performed by means of the tool and/or a heating element of the food processor. A food preparation operation may be performed by means of a cooling element of another kitchen appliance. A food preparation operation may comprise individual food preparation processes, also referred to as processes for short. A food preparation operation may be based on one or more recipes. A food preparation operation may comprise processes performed in or using at least one further kitchen appliance. For example, a further kitchen appliance may be a mixing device in the sense of the European patent application with official file number 20 175 328.2, a hot plate, a pan with a control, an oven, a grill, a refrigerator, a freezer, a microwave, or a thermometer. Another food processor is also possible. Information from functional components of the food processor and/or received information from another kitchen appliance may be used to perform a food preparation operation. A food preparation operation may comprise outputs to the user, such as displays and/or notifications. For example, the visual display of step-by-step instructions may be comprised, by means of which the user is guided through a recipe during the food preparation process step by step.

A food preparation process is an operation carried out by a functional component of the food processor or another kitchen appliance in which a food is processed with the purpose of preparing it. Examples of such processes are mixing, chopping, heating in the food preparation vessel or heating in the oven, in a microwave or on a grill. A functional component is a technical unit that can be electrically operated to operate a kitchen appliance and/or perform a process. The food processor comprises as functional components, for example, the tool with the associated drive.

A food preparation operation is an operation in which a food is processed. Beverages, sauces, food ingredients, unprocessed or partially processed mixtures of ingredients, etc. are comprised by the term food as used in the present disclosure. The food processor may comprise a scale to weigh ingredients that the user adds to the food preparation vessel, for example.

In particular, the individual processes for food preparation and/or the food preparation operation are controlled by means of the control unit. In particular, the control unit is configured to set operating parameters of individual functional components to perform processes. The control unit can be configured to control processes of further kitchen appliances. In other words, the control unit may be caused by a recipe step of the recipe to operate functional components of at least one further kitchen appliance in a manner defined by the recipe step. The control unit typically sends commands to the functional components, such as the drive of the tool or the heating element, such that the functional components are operated in response to the commands in accordance with the commands. In one embodiment, the recipe is stored in an external system, such as a cloud, server, cloud-based computer system, or mobile communication device, such as a cell phone, smartphone, or tablet computer. In an alternative or complementary embodiment, the recipe is stored in the control unit, in the food processor, and/or in a kitchen appliance. Control unit can access the recipe by means of a fixed data line or wirelessly.

Preferably, the control unit is arranged in the food processor and/or is part of the food processor. In an alternative or complementary embodiment, the control unit is provided in an external system, outsourced to a cloud, arranged in a server, part of a cloud-based computer system, or provided by a mobile communication device such as a cell phone, smartphone, or tablet computer. An external computer may be the control device.

In particular, the control unit is configured to determine and provide operating parameters and/or to initiate the output of information. Information to be output can include a signal, an alarm, an instruction and/or a content-related indication regarding a food preparation operation.

In one embodiment, the control unit can define a desired time before or at the start of a food preparation operation based on a current time, the scheduled duration of the selected recipe steps and optionally the duration of at least one buffer time, at which the food preparation operation is to be completed. In one embodiment, the desired time is provided in the form of a point in time, in particular by addition with a start time, and is compared with a point in time corresponding to the actual time. A desired time for a completion of at least two recipe steps describes the time or duration for completion as scheduled. The two recipe steps can be successively in time or in parallel in time.

When defining the desired time, values determined on the basis of parameters can be used, e.g. on the basis of the respective recipe and the arrangement of the recipe steps, taking into account the available resources. Buffer times can be provided between recipe steps, for example when defining the desired time.

The provision of buffer times is performed in particular when activities of the user are necessary. The reason for this is that delays are regularly caused by users. For example, if a desired time is 10 minutes for peeling potatoes, a buffer time of two minutes can be added, i.e. 20%. In one embodiment, a buffer time is also provided for activating or pressing a start button.

A buffer time may be provided if it is necessary to switch between the food processor and another kitchen appliance. Predefined or typical values can be used.

Buffer times can be scheduled in an automated manner by the control unit, for example. Buffer times can be based on electronically stored empirical values. Buffer times can be calculated by the control unit.

In one embodiment, an actual time is determined using one/or more sensors and/or measuring devices.

In one embodiment, a desired time for completion of the entire food preparation operation is defined as the desired time. The completion of the entire food preparation operation means the completion of all recipe steps of one or more recipes for preparing one or more foods. Thus, a desired time for the complete preparation of the one or more foods is defined. This is preferably defined in addition to the desired time for completion of the at least two recipe steps, but can also be defined alternatively. It is monitored during the food preparation operation by comparison with at least one actual time. In addition to the desired time for the overall completion, at least one and preferably several desired times for partial completion sections are defined in particular. These are, for example, desired times for individual food preparation processes or individual recipe steps. The completion of the food preparation operation is monitored during the food preparation operation in particular in such a way that, in the event of deviations from desired times for partial completion sections, measures are taken to achieve the desired time for overall completion. This enables a particularly high level of user-friendliness, since it is recognizable for the user when the food preparation operation has been completed.

In one embodiment, when a control unit compares a desired time during the preparation of the food to an actual time, the comparison may be between a beginning and an end of a single recipe step or a single process, and/or the desired time may relate to a duration within a single recipe step or a single process.

In one embodiment, a plurality of desired times is defined by the control unit, in particular for monitoring the food preparation operation, a single recipe step or a single process. In this way, particularly precise monitoring and/or regulation can be performed between a start and an end of a food preparation operation, a single recipe step or a single process. By regulation is meant the initiation of measures that serve to compensate as best as possible for a deviation determined by means of monitoring. For example, measures introduced aim to achieve a desired time in the future despite a deviation, in particular with a scheduled condition of the food to achieve a reproducible cooking result.

In one embodiment, a desired time is linked to a condition so that when the condition is met, the desired time is compared to the actual time. The actual time is thus measured when the condition is met and compared with the desired time. If there is a deviation or if the deviation exceeds a threshold value, a predefined action can be initiated, in particular even before the current recipe step or process is completed. The condition can be a condition of the food or a condition from inside the food preparation vessel. For example, the condition may be a temperature inside the food preparation vessel, which may be measured by a temperature sensor of the food processor. A desired time may be linked with reaching a defined temperature that is achieved during a scheduled cooking of a food. When the defined temperature is reached and the actual time then measured differs from the desired time, the temperature may be increased in case of a delay to meet or approach in an improved manner the scheduled desired time for the entire process or recipe step by the end of the process or recipe step. In another example, the condition may be an imbalance that can be determined by means of a scale of the food processor. The imbalance may be indicative of the texture of a dough in the food preparation vessel. If the defined imbalance is reached and the actual time then measured deviates from the desired time, the speed of rotation can be increased in case of a delay to meet or approach in an improved manner the scheduled desired time for the entire process or recipe step by the end of the process or recipe step.

In one configuration, a measure is initiated when a deviation of the actual time from the desired time is determined. In one configuration, this occurs only when the actual time exceeds a threshold value. In particular, the measure is performed to cause a future comparison of the desired time with the then current actual time to have a smaller deviation or no deviation. Accordingly, the measure may be a measure to align a future actual time with the desired time. In this way, completion according to the desired time can be achieved. For example, recipe steps or food preparation processes can automatically be adjusted to a time delay, which is for example due to a behavior of a user. Accordingly, in a system according to the present disclosure, the duration until completion of one, several or all recipe steps and/or the behavior of the food processor changes depending on external influences such as the behavior of the user. In other words, an adaptive system is provided which reacts to deviations during the preparation process and performs adjustments if necessary.

The threshold value defines a tolerance range within which no measure is necessary. The threshold value can be a predetermined threshold value stored in the recipe or elsewhere, or defined by the control unit. For the definition, input from a user may be taken into account. For example, if the target is to complete the recipe as quickly as possible, a comparatively small threshold value can be defined. In this case, only small tolerances with regard to the completion time are desired.

In one configuration, at least one desired time for a completion of a partial section of at least one recipe step is additionally defined and/or desired times for the recipe steps to be performed are continuously defined. In particular, a comparison of the desired time with the actual time of the food preparation operation is performed during the performance of a recipe step at least once, for example several times, in particular as often as possible. Thus, it is not only monitored at the end of a recipe step, but regularly and in particular as often as possible, whether the desired time or desired times are adhered to. This means that measures can also be initiated during one or more ongoing food preparation processes.

In one configuration, the control unit is configured such that an adjustment of at least one current or future recipe step is performed when a deviation of the actual time from the desired time is determined and, in particular, exceeds a certain threshold value.

A current recipe step is a recipe step of the current food preparation operation that is currently being processed. A future recipe step is a recipe step of the current food preparation operation that has not yet started. An adjustment typically means a change of at least one operating parameter of a functional component.

An operating parameter is a parameter with which a functional component can be operated. An operating parameter may be a parameter of a functional component of the food processor or the further kitchen appliance for performing the food preparation operation. For example, the operating parameter may be a parameter of a tool or a heating element such as a speed, a motor current, a temperature, a time duration, or a start time of a food preparation operation. The food processor may be configured to change operating parameters of the tool and/or heating element when a deviation is determined. By changing an operating parameter, for example, the temperature and/or the speed may be reduced by or to a specific value. In particular, at least one operating parameter is changed compared to the corresponding specification of the recipe. The change may involve one or more parameters of a functional component, such as a tool or a heating element. As an operating parameter, the change may concern a start time of a food preparation process or recipe step and consist in a delayed execution of the process with respect to a recipe.

In one embodiment, the control unit is configured such that an adjustment of a duration of at least one current or future recipe step or process is performed and/or an adjustment of a start time of a future recipe step or process is performed. The adjustment of the duration and/or the start time is performed when a deviation of the actual time from the desired time is determined and, in particular, if the deviation exceeds a certain threshold value.

By adjusting a duration, subsequent food preparation processes can be postponed. The adjustment can bring forward or delay the completion of at least one recipe step. In particular, the adjustment is performed with a specific target. This may consist, for example, in ensuring compliance with the desired time or in completing one or more foods as quickly as possible.

The adjustment of the start time of a future recipe step can be performed by reducing or setting to zero a buffer time between the future recipe step and the recipe step to be performed before it. Such buffer times are provided in particular to take into account activities of the user whose durations cannot be predicted or can be predicted only imprecisely. The reduction of the buffer time is a simple measure to reduce a remaining time for the completion of the food preparation operation.

The adjustment of the start time can be performed by taking at least one measure to ensure completion at the scheduled time in case of a too early completion of at least one recipe step. This can be performed, for example, by inserting pause times, keeping warm at least partially completed foods or parts of foods, adjusting operating parameters and/or rescheduling outstanding recipe steps.

The adjustment of the start time of a future recipe step can be performed by inserting or increasing a pause time between the future recipe step and the recipe step to be performed before it or between two processes. Such pause times are a simple measure to increase a remaining time for completion of at least one recipe step.

The adjustment of the start time can be performed by bringing forward at least one subsequent recipe in case of an earlier completion of at least one recipe step. This is not a matter of course at least when different foods are prepared in parallel with different kitchen appliances. In this way, the completion of the affected path and thus the affected part of the food is brought forward as a whole. The adjustment of the start time can be performed by bringing forward in time one, several and in particular all subsequent independent recipe steps in case of an earlier completion of at least one recipe step. In one embodiment, an adjustment of at least one start time is performed in case of an earlier actual time in the critical path compared to the desired time. The critical path is the path that determines a minimum duration to completion, in particular without time gaps. In one configuration, all recipe steps of one or more independent paths are brought forward in time. In this way, the completion of all food parts or foods of the prepared recipe is completed earlier.

In one configuration, the control unit is configured to initiate a keep-warm operation as part of an adjustment. The keep-warm operation is typically performed after a recipe step according to which a food or a part thereof has been partially or completely completed. In other words, in this configuration, the sequence of recipe steps is performed unchanged and at the end of a section of the food preparation operation, a completed part of the food or a completed food is kept warm. In particular, the control unit is configured to define an operating parameter of a device for keeping warm, for example based on a recipe step. The device for keeping warm may be, for example, a heatable food preparation vessel, such as an oven or a heatable food preparation vessel with an integrated heating element of a food processor. In particular, the control unit is configured to operate the device for keeping warm accordingly. The keep-warm operation can be inserted as an additional recipe step in a sequence of recipe steps. Appropriate instructions can be issued to the user.

In one configuration, the control unit is configured to insert an additional recipe step or define an optional recipe step as mandatory to increase a remaining time for completion. This can be performed, for example, if predetermined boundary conditions are present. For example, a roast may be cooked in an oven while at the same time a sauce is prepared in a food processor. The target is to complete the roast and the sauce at the same time so that the resulting meal will be completed at a specific time. If there is a delay in the path of the sauce, that is, in the recipe steps used to prepare the sauce, it may be appropriate to extend the path of the roast to ensure simultaneous completion. Simply extending the cooking time in the oven is not appropriate, as the roast may become too dry. However, in this example, the temperature in the oven can be reduced and, under this condition, the cooking time in the oven can be extended. Alternatively or complementarily, additional addition of water and/or cream may be provided to extend the cooking time in the oven without negatively affecting the food preparation.

The type and/or amount of adjustment can be performed depending on the size of the deviation. If the deviation is smaller but above the threshold value, it may be sufficient to postpone a subsequent process or recipe step slightly and/or to shorten at least one buffer time. In the case of a larger deviation, on the other hand, it may be necessary to shorten a subsequent recipe step by a certain amount of time.

It is possible that food preparation operations are performed at least temporarily at the same time, for example by means of the food processor and one or more other kitchen appliances. In this case, the food preparation operation is performed at least temporarily on different paths. Here, it is possible that the deviation of the actual time from the desired time affects only one of the paths. An adjustment of a duration and/or a start time initially affects in particular only the path in which the deviation occurs. The adjustment thus only affects the subset of subsequent food preparation processes and/or recipe steps that are performed in the path.

In one configuration, the at least one food preparation process of another path not affected by the deviation is continued unchanged. In a further configuration, a duration and/or a start time of a recipe step of the other path is adjusted. For example, it is possible that there has been a delay in the first path and the foods produced by means of the two paths are needed at the same time to be further processed together. In this case, for example, a pause time between recipe steps of the other path can be increased and/or at least one recipe step of the other path can be performed for a longer time.

In one configuration, the control unit is configured such that a critical path is designated and taken into account when adjusting the duration and/or start time. The designation and/or taking into account can be performed continuously. A critical path is a path whose food preparation processes allow no or only insignificant shortening, whose processing time is longer than the processing time of the at least one further path and/or which has the lowest or no buffer time. In one embodiment, measures are initiated mandatorily which have the effect of shortening the food preparation process if a time delay has been detected by the control unit for a critical path. For other paths, this is at least not mandatory.

In one embodiment, the control unit is configured such that at least one operating parameter of a current or future recipe step or food preparation process is adjusted when a deviation of the actual time from the desired time is determined. Advantageously, this only occurs if the deviation exceeds a certain threshold value. The control unit can send corresponding commands or operating parameters to a functional unit so that the latter is operated with one or more adjusted operating parameters in response. Such adjustment of operating parameters may be performed to speed up a cooking process. For example, a higher temperature, a steeper heating curve, a higher power, and/or a higher mixing speed may be set. A steeper heating curve will result in faster attainment of a target temperature and thus faster completion. A higher mixing speed may result in increased heat transfer and thus faster completion. Adjusting operating parameters can be performed to slow down a cooking process. For example, a lower temperature, flatter heating curve, lower power, and/or lower speed can be set.

In particular, a critical path is determined, for example by the control unit, and an operating parameter of a recipe step of the critical path is adjusted. A critical path usually comprises an automatic preparation and/or cooking step, since the critical path principally concerns the longest food preparation process.

In a further embodiment, the control unit is configured such that it defines or can define a start time of a food preparation process or recipe step. The assignment and/or definition is performed when a deviation of the actual time from the desired time is determined and, preferably, when the deviation exceeds a certain threshold value. The start time may refer to a kitchen appliance. However, the start time may also be provided for an activity by a user.

By means of an assignment by the control unit, it can be defined with which kitchen appliance and/or with which functional component a food preparation process is to be performed. The assignment of the food preparation process to an available kitchen appliance and/or to an available functional component means, in the case of an adjustment, a changed and thus new assignment, i.e. a rescheduling of one or more outstanding recipe steps. All remaining recipe steps or food preparation processes can be reassigned to respective available functional components. This can lead to a modified distribution of recipe steps and/or food preparation processes to the available kitchen appliances as well as functional components. A changed sequence of remaining recipe steps may be the consequence. On the whole, a changed sequence could have the effect that to the desired time for the completion of the food preparation operation is adhered to.

It is also possible to provide for further parallelization by using more kitchen appliances and/or making better use of kitchen appliances already in use. For example, recipe steps that still need to be processed can be distributed among the available kitchen appliances in a time-efficient manner In particular, processes that do not directly serve to process a food, such as preheating an oven, can also be assigned accordingly or defined in terms of their start time.

In particular, it is possible to provide further kitchen appliances also during a food preparation operation in order to integrate them into the food preparation operation, in order to achieve in this way, if necessary, an accelerated completion compared to the initial schedule. In particular, the control unit is configured to determine during the food preparation operation another available kitchen appliance or at least one functional component of at least one available further kitchen appliance for performing the food preparation processes of the remaining recipe steps. Thus, an additional kitchen appliance may be provided and integrated into the current food preparation operation if it is foreseeable that on-time completion cannot be guaranteed with the available kitchen appliances. In one embodiment, when recipe steps are to be performed manually by the user, another person, i.e., a second user, is integrated into the current food preparation operation if another person is available.

In one configuration, the control unit is configured to take into account the food preparation processes currently being performed when assigning a food preparation process to at least one available kitchen appliance and/or to an available functional component and/or when defining a modified start time. In this way, the assignment can be performed at any time during the performance of the food preparation operation without the need to interrupt processes or wait for a pause. Appropriate times for a changed sequence are determined so that they can be used seamlessly.

In one configuration, the assignment of a food preparation process to at least one available kitchen appliance and/or to at least one available functional component and/or the definition of the start time is performed such that dead times of at least one kitchen appliance are minimized. Dead times are times during a food preparation operation when a kitchen appliance is not in use. The minimization of dead times can be performed by minimizing a sum of dead times of one kitchen appliance, several kitchen appliances or all kitchen appliances.

The minimization of dead times can be performed such that a first kitchen appliance has priority over at least one other and in particular over all other kitchen appliances and dead times of the first kitchen appliance are minimized In this way, a kitchen appliance can be used for food preparation in a preferable manner. The kitchen appliance that is to be used preferably may be a kitchen appliance with the greatest range of functions. By this, the number of kitchen appliances required can advantageously be minimized

In a further embodiment, the control unit is configured such that a specified target entered by the user can be taken into account when assigning.

In this configuration, the system is configured such that the user can input a specified target. In particular, the system, for example the food processor, comprises an input unit for inputting the specified target by the user.

In principle, an initiated measure serves a specific target. This can consist, for example, of adhering to a desired time, completing the food at a specific time, or completing the food as quickly as possible.

In order for the control unit to be able to control the food preparation in a simple manner, the information of a recipe may comprise that one recipe step is dependent on another recipe step. This means that the first-mentioned recipe step can only be executed after the other recipe step has been executed. Thus, the recipe may include the information for the system that the aforementioned third recipe step depends on the second recipe step. The recipe may include information for the system that the aforementioned second recipe step depends on the aforementioned first recipe step. The control unit advantageously takes into account such dependencies for a control of the food preparation in order to avoid impossibilities.

In one embodiment, a recipe for a recipe step includes information for the system on which other recipe step the recipe step is dependent, wherein a distinction is made between at least two different dependencies. For example, a distinction can be made between a direct dependency and an indirect dependency.

There is a direct dependency between a first and a second subsequent recipe step if the second recipe step must be carried out with the same food processor immediately after the first recipe step. It is then not possible to first execute the first recipe step with the food processor, followed by a third recipe step and then the second recipe step. It is also not possible to execute the second recipe step before the first recipe step.

There is an indirect dependency between a first and a second subsequent recipe step when a third recipe step can be performed between a first and a second recipe step, wherein the first and the second recipe step are not performed with the same food processor. Again, it is not possible to perform the second recipe step prior to the first recipe step.

If a second recipe step must necessarily be performed immediately following a first recipe step with a kitchen appliance, then this is a direct dependency. If this information is stored for the system, then the sequence first recipe step, third recipe step, second recipe step is not a sequence that is possible, wherein the third recipe step is a recipe step that is also to be performed with the kitchen appliance. The sequence first recipe step, third recipe step, second recipe step is then not a possible combination that the control unit can take into account.

If a second recipe step must be performed following the performance of a first recipe step and if the same kitchen appliance is not required for both recipe steps and if a third recipe step can be performed between the first recipe step and the second recipe step, this is therefore an indirect dependency. If this information is stored for the system, then the sequence first recipe step, third recipe step, second recipe step is a sequence that is possible, and thus a possible combination that the control unit can take into account. Executing the second recipe step before the first recipe step is then not a possible combination that the control unit can take into account.

In the case of an indirect dependency, the control unit thus knows that sequences of recipe steps can be swapped, but that swapping is not possible at will. In the case of a direct dependency, the control unit knows that sequences of recipe steps can be interchanged. Control is thus facilitated by means of such existing dependency information.

Further explanations and details of the advantages are described in the European patent application with the official file number 20 154 494.7, to which we hereby refer and which we hereby incorporate in its entirety.

In one embodiment, the control unit is configured such that it determines whether a recipe step has a dependency on at least one other recipe step. Dependencies do not necessarily have to be stored in a recipe.

In one embodiment, the control unit is configured such that a number of users greater than or equal to two is taken into account when assigning the food preparation process or recipe step and/or defining the start time.

In other words, the control unit is configured to perform the assignment of a food preparation process to at least one available functional component and/or the definition of the start time in such a way that several users are taken into account. For example, the outstanding recipe steps are scheduled in such a way that activities can take place independently of each other and/or simultaneously. For example, at least one path is defined for each user, which comprises activities to be performed and kitchen appliances to be used for food preparation processes. A kitchen appliance can be used by different users at different times, i.e. it can be part of several paths one after the other. Several users can prepare one or more foods in a flexible way using several kitchen appliances. Food preparation by multiple users enables the preparation of many and/or complex foods and/or a shorter preparation duration. In this case, the use of available kitchen appliances and the prevention of dead times are particularly efficient. Guided cooking for several people up to groups of people, possibly using a variety of kitchen appliances and/or for preparing a variety of foods, is made possible.

In a further embodiment, the control unit is configured to determine available food preparation appliances and/or available functional components of at least one further kitchen appliance, in particular food preparation appliance, for performing the food preparation processes of the recipe steps.

In other words, the control unit can determine which further kitchen appliances or functional components of further kitchen appliances are available in addition to the functional components of the food processor, i.e. the tool and/or the heating element. For this purpose, available kitchen appliances can be determined in a first step. The respective functional components of the available kitchen appliances may be determined in a second step. The system can be configured such that the determination can be started manually and/or that a determination is performed if certain conditions are present. The system can also be configured such that a further kitchen appliance brought into the vicinity of the food processor is automatically determined or detected.

The determination of the kitchen appliances and/or functional components (i.e., their capabilities) can be performed, for example, by providing an input facility for the user by means of which the user can enter the available kitchen appliances and/or the associated available functional components. The determination of the kitchen appliances and/or functional components may be performed by producing a wired or wireless connection between a transmitting and/or receiving unit in data communication with the control unit and any available kitchen appliances. The determination of the kitchen appliances and/or functional components may be performed by scanning which kitchen appliances are present in an environment. Subsequently, it may be possible that a list is generated from which the user can select the actually desired kitchen appliances. In this way, a semi-automated determination of the kitchen appliances and/or functional components can be performed.

It is possible that the control unit has access to a data set in which functional components comprised by various kitchen appliances are stored, so that the control unit can identify the respective functional components, i.e. their capabilities, on the basis of the type or designation of the available kitchen appliance. It is possible that the respective functional components of the kitchen appliances are transmitted to the control unit by means of the aforementioned connection. This enables fully automated determination of the functional components. For example, a connection and/or scanning may be implemented using one of the following techniques: USB, Bluetooth, Wi-Fi, near field communication (NFC), optical detection, for example by recognizing coded information such as QR codes or by means of automatic image recognition. These techniques can also be used to capture the individual functional components of the respective kitchen appliances.

The determined kitchen appliances or functional components of kitchen appliances can be used, for example, to assign food preparation processes or recipe steps to them and/or to perform food preparation processes. This embodiment enables a particularly flexible response to deviations, so that the reproducibility of food preparation is further improved.

In one further embodiment, the control unit is configured such that a completion of a recipe step is detected by a user input, by an action of a user, or by a detection of a predefined state.

Detection of the completion of a recipe step is performed in particular to determine the actual time for comparison with the desired time. In particular, the control unit detects the completion of the recipe step. For example, the completion of a recipe step can be detected by a user performing a corresponding operation by means of an input unit of the food processor. For example, the food processor may have a touch-sensitive display as an input and output unit, and an operation of a virtual “Next” button serves to confirm completion of a recipe step.

For example, an action of the user may be placing a food in an oven, removing a food from a food preparation vessel, or manually setting a particular operating parameter of another kitchen appliance. In particular, the system comprises a device for detecting the action of the user, such as a sensor.

The detection of a predefined state may, for example, be the detection of a specified temperature. The latter may be stored in the recipe, for example. For example, the completion of the recipe step “preheat oven” can be detected by the fact that the target temperature is reached. In particular, the system comprises a device for detecting a predefined state, such as an internal or external sensor. In particular, the system comprises a thermometer capable of exchanging data via a wireless connection. It is also possible to detect a predefined consistency of a dough to be produced, for example on the basis of a determined current consumption of an electric motor for driving the tool and/or on the basis of a curve of the current consumption. This embodiment enables particularly flexible control of food preparation.

In one configuration, the system comprises, in addition to a food processor, at least one further kitchen appliance for performing a food preparation operation. The further kitchen appliance may be, for example, a mixing device in the sense of the European patent application with the official file number 20 175 328.2, a hot plate, an oven, a microwave oven or a thermometer.

To enable the control unit to control reliably and easily, the information of a recipe for a recipe step may comprise an indication of which kitchen appliance is required to perform a recipe step. Two or more kitchen appliances may also be provided for selection for a recipe step.

In one embodiment, the system comprises at least two kitchen appliances and an electronic resource storage device for storing a list of kitchen appliances comprised by the system and/or for storing the number of users available for preparing one or more foods. The system comprises a recipe storage device for storing at least one recipe for preparing at least one food. The control unit is configured such that it optimizes the preparation of one or more foods, taking into account information for the system comprised by a recipe. There is then an optimized sequence of recipe steps, which may be different from the sequence originally provided by a recipe. This may be a sequence of recipe steps, wherein the recipe steps may originate from different recipes. This optimization occurs before the recipe steps are performed. For example, optimization may have been performed such that two foods are ready at the same time. Following optimization, the food is prepared according to the optimized sequence of recipe steps, taking desired times and actual times into account as described above.

The measures described in the European patent application with the official file number 20 154 494.7 for the initial optimization of the sequence of recipe steps are hereby included in the disclosure of this application. The control unit according to the present disclosure may then take over the tasks of the optimization device known from the publication. Thus, it is part of the systems and methods of the present disclosure that at the beginning of a preparation of one or more foods, the preparation is first optimized as described in the European patent application with the official file number 20 154 494.7.

A further aspect of the present disclosure relates to a method of preparing a food comprising the steps of:

accessing a recipe,

controlling a food processor and/or a kitchen appliance for preparing the food by at least one recipe step of the recipe, and

comparing a desired time during preparation of the food or for a completion of at least two recipe steps with an actual time.

In one configuration of the method, the following steps are further provided:

determining available functional components of the food processor and/or the at least one kitchen appliance for performing a food preparation process of at least one recipe step,

assigning the food preparation processes defined in the at least one recipe step to the available functional components, and

modifying the recipe by changing the timing of the food preparation processes relative to each other for shortening the completion of the food.

Modifying the recipe for shortening the completion of the food, e.g. by parallelizing processes by dividing them among several kitchen appliances and/or modifying the time sequence of the processes depending on the availability of the functional components has already been explained in more detail above.

A further aspect of the present disclosure relates to a computer program product or computer-readable medium comprising instructions which, when executed by a processor which is in particular part of the control unit, cause the processor to perform the steps of the method described above according to the preceding aspect of the present disclosure.

1. A system comprising:
a food processor including a food preparation vessel and configured to prepare a food in the food preparation vessel;
an additional kitchen appliance; and
a control unit communicatively coupled to the food processor and the additional kitchen appliance to selectively control operation of the food processor and the additional kitchen appliance, the control unit being configured to:
access a recipe stored in memory of the control unit, the recipe having a plurality of recipe steps,
control the food processor and the additional kitchen appliance to prepare the food according to one of the plurality of recipe steps,
compare a desired time to complete the one of the plurality of recipe steps and an actual time to complete the one of the plurality of recipe steps,
in response to a difference between the desired time and the actual time being greater than a threshold, adjust a time period for performing a next one of the plurality of recipe steps to shorten the time period, and
control at least one of the food processor and the additional kitchen appliance to prepare the food according to the adjusted time period of the next one of the plurality of recipe steps within thereby speeding up preparation steps of the recipe to adhere to a scheduled completion time for the recipe.

2. The system of claim 1, wherein, in response to the difference between the desired time and the actual time being greater than a threshold, the control unit is configured to redefine a start time of the next one of the plurality of recipe steps.

3. The system of claim 1, wherein the control unit is configured to divide among a plurality of kitchen appliances and assign to the plurality of kitchen appliances a recipe step or a food preparation process defined in a recipe step

4. The system of claim 3, further comprising a further kitchen appliance, wherein the control unit is configured to, in response to the difference being greater than a threshold, distribute the plurality of recipe steps among the food processor, the additional kitchen appliance, and the further kitchen appliance.

5. The system of claim 1, wherein the control unit is further configured to monitor an expected time of recipe completion, to update the expected time of recipe completion in response to adjustment of the time period for performing the next one of the plurality of recipe steps to shorten the time period, to compare the expected time of recipe completion with an original schedule, and to inform a user that the food will not be ready until a time beyond the original schedule if the expected time of recipe completion exceeds the original schedule.

6. A system comprising:
a food processor for preparing a food in a food preparation vessel and/or another kitchen appliance, and
a control unit configured to access a recipe and control the preparation of the food according to a recipe step of the recipe, wherein the control unit is configured such that it:
compare a desired time for preparing the food and an actual time for preparing the food,
compare a desired time for a completion of at least two recipe steps and an actual time for the completion of the at least two recipe steps, and
in response to detecting that the desired time is different from the actual time, to adjust a duration of performing at least one current or future recipe step, and/or adjust a start time of the future recipe step.

7. The system of claim 6, wherein the control unit adjusts the duration and/or the start time in response to a difference between the desired time and the actual time being greater than a predefined threshold value.

8. The system of claim 7, wherein the control unit is configured to adjust at least one operating parameter provided according to recipe step in response to determining that the actual time is different from the desired time, and wherein a difference between the actual time and the desired time exceeds a predefined threshold value.

9. The system of claim 7, wherein the control unit is configured to redefine a start time of a food preparation process in response to determining that the actual time is different from the desired time, and wherein a difference between the actual time and the desired time exceeds a predefined threshold value.

10. The system of claim 6, wherein the control unit is configured to divide among a plurality of kitchen appliances and assign to the plurality of kitchen appliances a recipe step or a food preparation process defined in a recipe step.

11. The system of claim 10, wherein the control unit is configured to assign a recipe step to one of the plurality of kitchen appliances based on a previously received user-specified target completion time.

12. The system of claim 11, wherein the control unit is configured to, in response to determining that a recipe step has a dependency on at least one other recipe step, assign the food preparation process and/or define the start time based on the dependency.

13. The system of claim 12, wherein the control unit is configured to assign recipe steps to the plurality of kitchen appliances and/or to define the start time based on inputs of two or more users.

14. The system of claim 6, wherein the control unit is configured to one of:
define a buffer time for at least one recipe step, and
define the buffer time for each recipe step.

15. The system of claim 6, wherein the control unit is configured to determine functional components of at least one available further kitchen appliance for performing the food preparation processes of the recipe steps.

16. The system of claim 6, wherein the control unit is configured to determine that a recipe step has been completed in response to detecting one of a predefined user input, a predefined user action, and a predefined state.

17. The system of claim 6, further comprising at least two kitchen appliances and an electronic resource storage device configured to store data indicative of the at least two kitchen appliances and/or store a number of users available for preparing one or more foods.

18. A method for preparing a food, the method comprising:
accessing, by a control unit, a recipe;
controlling a food processor and/or kitchen appliance for preparing the food by at least one recipe step of the recipe; and
comparing an actual time and one of a desired time during preparation of the food and a desired time for a completion of at least two recipe steps.

19. The method of claim 18, further comprising
identifying available functional components of the food processor and/or the at least one kitchen appliance for performing a food preparation process of at least one recipe step,
assigning the food preparation processes of the at least one recipe step to the identified available functional components, and
modifying the recipe by changing a timing of the food preparation processes relative to each other to shorten a completion time for preparing the food.
